(19) United States
(12) Patent Application Publication
(10) Pub. No.: US 2021/0150630 A1
(43) Pub. Date: May 20, 2021

(54) CORPORATE TRAVEL SYSTEM

(71) Applicant: International Business Machines Corporation, Armonk, NY (US)

(72) Inventors: Joseph Dawson Davis, III, Roanoke, TX (US); John F. Hollingsworth, Wynnewood, PA (US); Baiju Dhirajlal Mandalia, Boca Raton, FL (US)

(21) Appl. No.: 16/688,031

(22) Filed: Nov. 19, 2019

(51) Int. Cl. G06Q 40/00; G06N 20/00; G06N 5/04; G06N 3/00

(52) U.S. Cl. CPC G06Q 40/12; G06N 3/004; G06N 5/04; G06N 20/00

(57) ABSTRACT

A system for corporate travel is provided. One or more travel-related data for a given time period is determined. One or more expenditures based, at least, on the one or more travel-related data is determined. A graphical template based, at least, on an expenditure target is generated.

### BACKGROUND OF THE INVENTION

The present invention relates generally to the field of unstructured electronic documents, and more particularly to generating a user interface that leverages related datasets for at least unstructured electronic documents.

Business entities employ individuals to maintain the administrative burden of the business-related expenses associated with the various employees. Conventionally, administrative employees manually prepare expense-related data sheets based, at least, on static information provided. Additionally, administrative employees may not be aware of various datapoints due to, at least, unstructured electronic documents.

### SUMMARY

Embodiments of the present invention provide a method, system, and program product to manage a corporate travel system.

A first embodiment encompasses a method for managing a corporate travel system. One or more processors determine one or more travel-related data for a given time period. One or more processors determine one or more expenditures based, at least, on the one or more travel-related data. One or more processors generate a graphical template based, at least, on a expenditure target.

A second embodiment encompasses a computer program product for managing a corporate travel system. The computer program product includes one or more computer-readable storage media and program instructions stored on the one or more computer-readable storage media. The program instructions include program instructions to determine one or more travel-related data for a given time period. The program instructions include program instructions to determine one or more expenditures based, at least, on the one or more travel-related data. The program instructions include program instructions to generate a graphical template based, at least, on an expenditure target.

A third embodiment encompasses a computer system for managing a corporate travel system. The computer system includes one or more computer processors, one or more computer-readable storage medium, and program instructions stored on the computer readable storage medium for execution by at least one of the one or more processors. The computer program includes one or more computer-readable storage media and program instructions stored on the one or more computer-readable storage media. The program instructions include program instructions to determine one or more travel-related data for a given time period. The program instructions include program instructions to determine one or more expenditures based, at least, on the one or more travel-related data. The program instructions include program instructions to generate a graphical template based, at least, on an expenditure target.

### BRIEF DESCRIPTION OF THE SEVERAL VIEWS OF THE DRAWINGS

FIG. 1 is a functional block diagram illustrating a computing environment, in which a system for corporate travel is managed, in accordance with an exemplary embodiment of the present invention.

FIG. 2 illustrates operational processes of a system for corporate travel is managed on a computing device within the computing environment of FIG. 1, in accordance with an exemplary embodiment of the present invention.

FIG. 3 illustrates operational processes of a system for a corporate travel alert system is managed, on a computing device within the computing environment of FIG. 1, in accordance with an exemplary embodiment of the present invention.

FIG. 4 depicts a cloud computing environment according to at least one embodiment of the present invention.

FIG. 5 depicts abstraction model layers according to at least on embodiment of the present invention.

FIG. 6 depicts a block diagram of components of one or more computing devices within the computing environment depicted in FIG. 1, in accordance with an exemplary embodiment of the present invention.

### DETAILED DESCRIPTION

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While prior solutions to generating datasets based on unstructured documents are known, such prior solutions have been inadequate to identify datapoints disassociated with static information. Embodiments of the present invention recognize that prior solutions can be improved by proactively analyzing contract events, data points, and metadata from various individuals of one or more environments and identifying the occurrence of the various contract events that occur between the various employees.

Embodiments of the present invention provide a more effective and sustainable approach to identifying travel-related data by analyzing the various contract events, data points, and metadata and generate a scheduled set of events. Furthermore, the embodiments of the present invention provide an effective system for generating a scheduled set of events to generate a more accurate and predictable financial obligation.

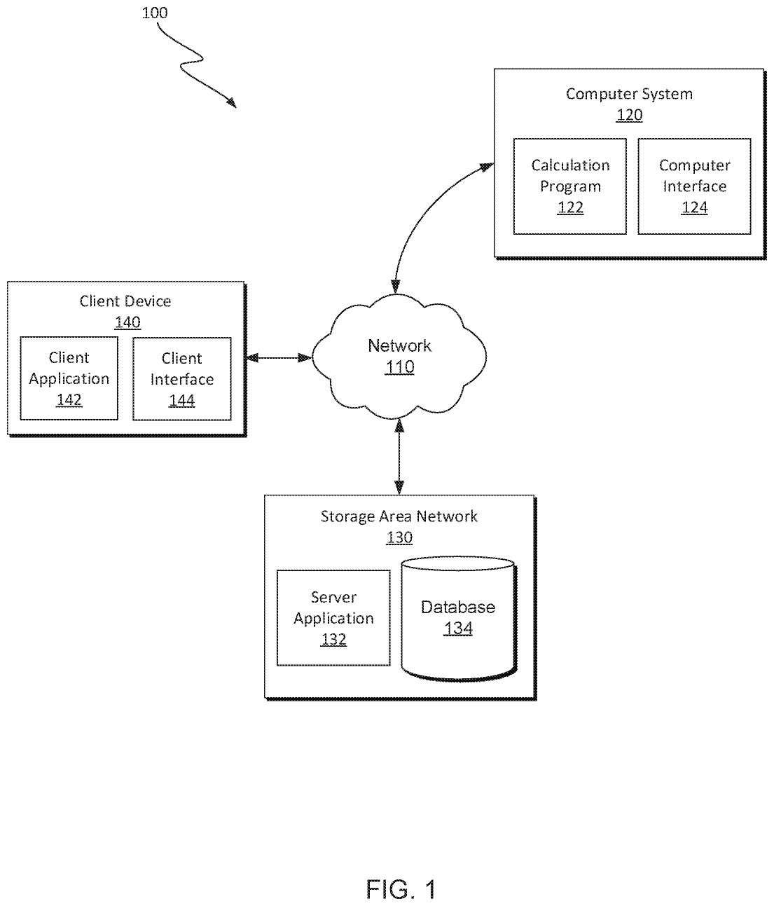

FIG. 1 is a functional block diagram illustrating a computing environment, generally, designated 100, in accordance with an embodiment of the present invention. Computing environment 100 includes computer system 120, storage area network 130, and client device 140. Computer system 120 includes calculation program 122 and computer interface 124. Storage area network (SAN) 130 includes server application 132 and database 134. Client device 140 includes client application 142 and client interface 144.

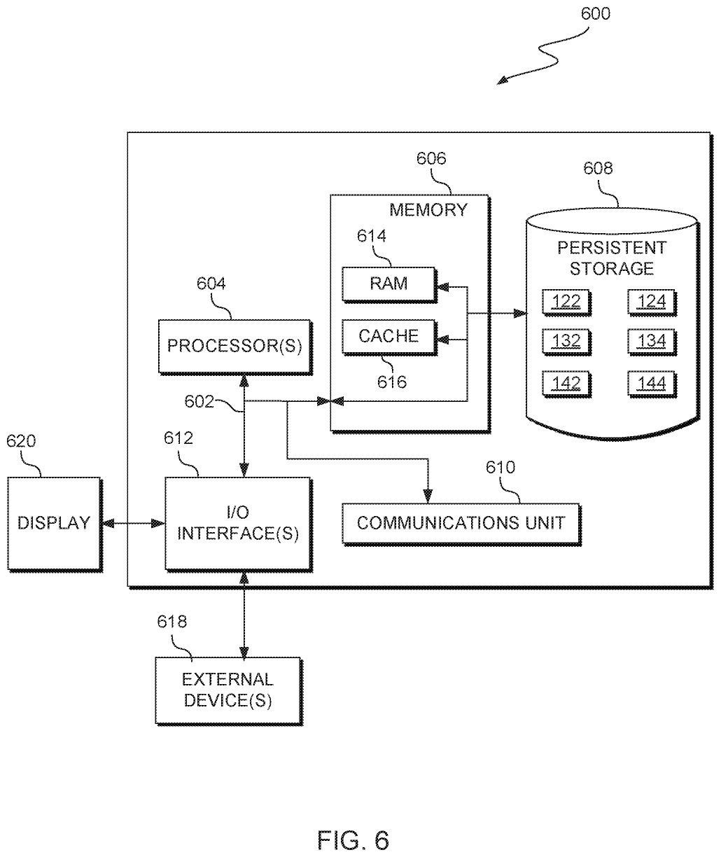

In various embodiments of the present invention, computer system 120 is a computing device that can be a standalone device, a server, a laptop computer, a tablet computer, a netbook computer, a personal computer (PC), a personal digital assistant (PDA), a smartwatch, a desktop computer or any programmable electronic device capable of executing machine readable program instructions and communications with SAN 130 and client device 140. In another embodiment, computer system 120 represents a computing system utilizing clustered computers and components to act as a single pool of seamless resources. In general, computer system 120 can be any computing device or a combination of devices with access to SAN 130, client device 140, and network 110 and is capable of executing calculation program 122 and computer interface 124. Computer system 120 may include internal and external hardware components as depicted and described in further detail with respect to FIG. 6.

In this exemplary embodiment, calculation program 122 and computer interface 124 are stored on computer system 120. However, in other embodiments, calculation program 122 and computer interface 124 may be stored externally and accessed through a communication network, such as network 110. Network 110 can be, for example, a local area network (LAN), a wide area network (WAN) such as the Internet, or a combination of the two, and may include wired, wireless or any other connection known in the art. In general, network 110 can be any combination of connections and protocols that will support communications between computer system 120, SAN 130, and client device 140, in accordance with a desired embodiment of the present invention.

Calculation program 122 is depicted in FIG. 1 for illustrative simplicity. In various embodiments of the present invention, calculation program 122 represents logical operations executing on computer system 120, where computer interface 124 manages the ability to view these logical operations on computer system 120. Computer system 120 can include any number of logical operations that are managed and executed in accordance with calculation program 122. In some embodiments, calculation program 122 represents a cognitive AI system that processes and analyzes input and output (I/O). Additionally, calculation program 122, when executing cognitive AI processing, operates to learn from the I/O that was analyzed and generate prediction model based, at least, on the analyzation operation. In some embodiments, calculation program 122 determines whether a specific action is likely to take place and generates a digital message and communicates an alert system to one or more users of client device 140.

Computer system 120 includes computer interface 124. Computer interface 124 provides an interface between computer system 120, SAN 130, and client device 140. In some embodiments, computer interface 124 can be a graphical user interface (GUI) or a web user interface (WUI) and can display text, documents, web browser, windows, user options, applications interfaces, and instructions for operation, and includes the information (such as graphic, text, and sound) that a program presents to a user and the control sequences the user employs to control the program. In some embodiments, computer system 120 accesses data communicated from SAN 130 and/or client device 140 via a client-based application that runs on computer system 120. For example, computer system 120 includes mobile application software that provides an interface between computer system 120, SAN 130, and client device 140.

Storage area network (SAN) 130 is a storage system that includes server application 132 and database 134. SAN 130 may include one or more, but is not limited to, computing devices, servers, server-clusters, web-servers, databases and storage devices. SAN 130 operates to communicate with computer system 120, client device 140, and various other computing devices (not shown) over a network, such as network 110. For example, SAN 130 communicates with calculation program 122 to transfer data between, but is not limited to, computer system 120, client device 140, and various other computing devices (not shown) that are connected to network 110. SAN 130 can be any computing device or a combination of devices that communicatively connected to a local IoT network, i.e., a network comprised of various computing devices including, but are not limited to computer system 120 and client device 140 to provide the functionality described herein. SAN 130 can include internal and external hardware components as described with respect to FIG. 6. The present invention recognizes that FIG. 1 may include any number of computing devices, servers, databases, and/or storage devices, and the present invention is not limited to only what is depicted in FIG. 1. As such, in some embodiments, some or all of the features and functions of SAN 130 are included as apart of computer system 120, client device 140 and/or another computing device. Similarly, in some embodiments, some of the features and functions of computer system 120 are included as part of SAN 130 and/or another computing device.

Additionally, in some embodiments, SAN 130 represents, or is part of, a cloud computing platform. Cloud computing is a model or service delivery for enabling convenient, on demand network access to shared pool of configurable computing resources (e.g., networks, network bandwidth, servers, processing, memory, storage, applications, virtual machines, and service(s) that can be rapidly provisioned and released with minimal management effort or interaction with a provider of a service. A cloud model may include characteristics such as on-demand self-service, broad network access, resource pooling, rapid elasticity, and measured service, can be represented by service models including a platform as a service (PaaS) model, an infrastructure as a service (IaaS) model, and a software as a service (SaaS) model; and can be implemented as various deployment models including as a private cloud, a community cloud, a public cloud, and a hybrid cloud.

In various embodiments, SAN 130 is depicted in FIG. 1 for illustrative simplicity. However, it is to be understood that, in various embodiments, SAN 130 can include any number of databases that are managed in accordance with the functionality of server application 132. In general, database 134 represents data and server application 132 represents code that provides an ability to take specific action with respect to another physical or virtual resource and manages the ability to use and modify the data. In an alternative embodiment, calculation program 122 can also represent any combination of the aforementioned features, in which server application 132 has access to database 134. To illustrate various aspects of the present invention, examples of server application 132 are presented in which calculation program 122 represents one or more of, but is not limited to, a local IoT network and contract event monitoring system.

In some embodiments, server application 132 and database 134 are stored on SAN 130. However, in other embodiments, server application 132 and database 134 may be stored externally and accessed through a communication network, such as network 110, as discussed above.

In one embodiment of the present invention, calculation program 122 defines a system for generating related datasets for one or more unstructured electronic documents for computer system 120 that has access to travel-related data on SAN 130 and has access to travel-related data on other computer system (e.g., various other computing devices).

In various embodiments, SAN 130 represents an internet-based service for storing and transcribing electronic documents and/or datasets. In various embodiments, SAN 130 encompasses software, servers, databases, web-servers, and web pages supported by software to operate and maintain an internet-based service for video sharing. Users of computer system 120 and/or client device 140 have access to databases maintained and supported by SAN 130 via any communicative connection known in the art. One or more users have the availability to edit, change, or alter the datasets stored on SAN 130 and are accessible by any communicate connection known in the art.

In various embodiments depicted in FIG. 1, calculation program 122 obtains travel-related data from client device 140 and/or SAN 130. In other embodiments, calculation program 122 obtains travel-related data from a user of computer system 120. As discussed above, SAN 130 represents an internet-based service for storing and transcribing electronic documents and/or datasets. Travel-related data is stored on database 134. However, in some embodiments, travel-related data can be stored on client device 140 and/or stored on various other computing devices (not shown). In various embodiments, travel-related data represents various corporate card expenses, travel-related itineraries (e.g., departure and landing of plane flights, time spent driving/traveling, etc.), internal requested time-off, travel-related activities (e.g., plane flights, lodging, car rentals, etc.), etc., and is stored on SAN 130.

In various embodiments of the present invention, a user of client device 140 (hereinafter “requestor”) generates a user request and communicates the request to computer system 120. In various embodiments, the user request is associated with a specific individual for whom the travel-related data is associated with. In various embodiments, the user request is associated with (i) one or more individuals and (ii) one or more travel-related data. Client application 142 generates the user request based on the user's direction and communicates the user request to computer system 120 to generate a travel-related schedule of events.

In various embodiments of the present invention, a user of client device 140 utilizing, client application 142 communicates travel-related data to SAN 130. Server application 132 executing on SAN 130 receives one or more travel-related data from, at least, one user of client device 140. In various embodiments, travel-related data includes, but is not limited to, time and dates in which the user will be traveling, lodging reservations (e.g., hotels, shared-room lodging, motels, extended stay, microstay, timeshare, boutique, luxury, homestay, etc.), travel-related expenses (e.g., a record account of expenses charged to a corporate card or through personal finances), etc. While various embodiments are discussed in regards to calendar days of the year for lengths of stay, one of ordinary skill in the art will recognize that any format or denomination of time and date data may be used for travel-related data without deviating from the invention—such as, but not limited to, check-in and check-out times or larger denominations (e.g., work-weeks) of stay.

In various embodiments of the present invention, calculation program 122 analyzes the travel-related data and identifies whether the travel-related time periods are associated with (i) business travel or (ii) personal travel. In some embodiments, calculation program 122 receives information from a user of client device 140 indicating whether the travel-related time period is associated with (i) business travel or (ii) personal travel. In an alternative embodiment, calculation program 122 analyzes the travel-related time period and determines whether the time period is (i) business travel or (ii) personal travel.

In various embodiments, calculation program 122 retrieves one or more expenditures associated with the one or more travel-related data. The present invention recognizes that travel-related data indicates events that incur expenses (e.g., plane flights, hotel stays, etc. have a cost associated with the travel-related activities). Calculation program 122 analyzes the one or more expenditures and determines the (i) total cost, (ii) the jurisdiction in which the cost was incurred, and (iii) the travel-related activity associated with the specific expenditure, and (iv) whether the expenditure is taxable. Calculation program 122 identifies the (i) total cost, (ii) the jurisdiction in which the cost was incurred, (iii) the travel-related activity associated with the specific expenditure, and (iv) whether the expenditure is taxable for the one or more expenditures. Calculation program 122 stores the data referenced above on database 134.

The present invention recognizes that a business entity contains a threshold maximum limit on taxable expenditures. In various embodiments, the business entity operates to establish the taxable-expenditure thresholds on, at least, a yearly basis which includes, but is not limited to, any numerical established by the business entity. In one example and embodiment, the business entity establishes a taxable-expenditure threshold of eight percent (8%) per month for a calendar year (e.g., eight percent (8%) per month for a given twelve-month period), which results in a ninety-six percent yearly total. In various embodiments, the taxable-expenditures are associated with the travel-related activities and the expenses that are incurred through those travel-related activities. In various embodiments, the taxable-expenditures represent time periods in which an individual conducts business in a given jurisdiction. In various embodiments, a user of client device 140 communicates travel-related data to SAN 130. In one example and embodiment, an individual traveling to state A and conducts business for two weeks on behalf of the business entity. The individual records the travel-related data for the time spent in state A on database 134, utilizing, at least, client application 142 to communicate the data to SAN 130.

In various embodiments of the present invention, one or more users of client device 140 communicate travel-related data to SAN 130. Additionally, the travel-related data includes, at least, data associated with various jurisdictions distributed across the globe. The present invention recognizes that the various jurisdictions include, but is not limited to, one or more States associated with the United States of America and one or more countries, and parts thereof, associated within the globe. Server application 132 executing on SAN 130 receives the travel-related data from client device 140 and stores the travel-related data on database 134.

In various embodiments of the present invention, calculation program 122 receives a user request from client device 140 to generate a schedule template. Additionally, the user request includes data that defines a schedule template. In various embodiments, the user request defines that the schedule template includes, but is not limited to, (i) jurisdictional data, (ii) time data, (iii) travel data, (iv) whether the jurisdiction includes taxable income, and (v) number of users associated with the business entity, etc. Calculation program 122 analyzes the user request and generates a template in a user interface based, at least in part, on the data associated with the schedule template. Calculation program 122 stores the schedule template on database 134.

In various embodiments, calculation program 122 generates a customized user interface, wherein the customized user interface is accessible by a user of client device 140. In some embodiments, calculation program 122 generates a customized user interface that includes, one or a combination of: (i) selectable options for travel, (ii) selectable options for jurisdiction-based taxable income, and (iii) selectable options for time and date of travel. In various embodiments, the customize user interface includes program instructions to auto-generate based on the populated template. In some embodiments, the graphical user interface manages travel based on the monthly and/or yearly threshold value. In some embodiments, the graphical user interface includes the ability to reschedule a trip for a given user based on the determination that the threshold value will be met and/or exceeded before the date of the given user's trip. In some embodiments, the graphical user interface reschedules the given user's trip for the next available priority which includes one or a combination of: (i) the subsequent month, (ii) the subsequent quarter, and/or (iii) the subsequent fiscal year.

In response to calculation program 122 generating the schedule template, calculation program 122 retrieves travel-related data from SAN 130. In various embodiments, calculation program 122 communicates a set of program instructions to server application 132 instructing server application 132 to query database 134 and retrieve various travel-related data associated, at least, with the user request received from client device 140. Additionally, the set of program instructions include program instructions to communicate the retrieved travel-related data to calculation program 122. In an alternative embodiment, calculation program 122 communicates with SAN 130 and calculation program 122 performs a query of database 134 to retrieve travel-related data associated with the user request received from client device 140.

Calculation program 122 receives travel-related data and analyzes the travel-related data. In various embodiments, calculation program 122 representing a cognitive AI model analyzes the travel-related data and populates the data into the proper categories of the schedule template. In various embodiments, calculation program 122 includes, or has access to, a cognitive AI model, a prediction model, or a comparison model. Additionally, calculation program 122 executing as a cognitive AI model analyzes the data and identifies various trend patterns in the data and learns from the travel-related data. The present invention recognizes that trend patterns represents various data that is similar and identifies and/or tracks the progress in which the data occurs. In one example and embodiment, calculation program 122 identifies an increase in travel-expenditures, and further identifies that the culmination of the users of client device 140 are reaching a threshold value for a given month for the taxable-expenditures. In another embodiment and example, calculation program 122 analyzes the travel-related data and does not identify an increase in travel-expenditures, and further identifies that the value of the travel-expenditures is lower than the projected rate at which the threshold value of travel-expenditures would be reached. Calculation program 122 stores this information on database 134 for subsequent use.

In various embodiments, calculation program 122 identifies a maximum threshold value associated with the user request. In various embodiments, the maximum threshold value is established by a primary user of client device 140 and the maximum threshold value represents a limit on the amount of travel-expenditures on a pre-determined basis or period of time (e.g., annually, quarterly, or monthly). In one embodiment, a primary user of client device 140 establishes a maximum threshold value and further divides the maximum threshold value among a yearly basis, (i.e., a twelve-month period of time). A primary user of client device 140 communicates the maximum threshold value and the division of the maximum threshold value to calculation program 122. In one example and embodiment, a primary user establishes a maximum threshold value and divides the maximum threshold value evenly among the twelve months in a year. The present invention recognizes that a primary user is a user who has authority granted to them by the business entity, and further the present invention does not limit whom the primary user is. Additionally, the present invention recognizes that the primary user may allocate and value to the maximum threshold value, and the present invention does limit itself to the embodiments hereto. In various embodiments, the division of the maximum threshold value includes any value distributed amongst a twelve-month period of time and the present invention does not limit itself to any value for a given month. The present invention does recognize that the distribution of the maximum threshold value over a twelve-month period of time cannot exceed one hundred percent (100%) of the maximum threshold value.

In various embodiments of the present invention, calculation program 122 identifies one or more travel-related expenditures associated, at least, with (i) one or more users of client device 140 and (ii) a given period of time (e.g., the month of January). Calculation program 122 calculates the total value of the travel-related expenditures associated with (i) one or more users of client device 140 and (ii) a given period of time (e.g., the month of January). In various embodiments, calculation program 122 executes a cognitive AI model to determine whether the total value of the travel-related expenditures will exceed the monthly threshold value for the given period of time. In various embodiments, calculation program 122 executes a cognitive AI model to analyze the data and determine whether the monthly threshold value will be exceeded based, at least in part, on the travel-related data submitted by the one or more users of client device 140.

In one embodiment and example, calculation program 122 identifies one or more travel-related expenditures associated with (i) one or more users of client device 140 and (ii) the month of January. Calculation program 122 calculates the total value of the travel-related expenditures submitted by the one or more users of client device 140. The present invention recognizes that calculation program 122 operates to execute the calculation step at any given period of time and is not limited to a specific date or time. Alternatively, calculation program 122 operates to calculate the total value of the travel-related expenditures each month when calculation program 122 receives additional travel-related data and travel-related expenditures.

In various embodiments of the present invention, calculation program 122 retrieves the one or more travel-related data communicated by, at least, the one user of client device 140 and calculation program 122 analyzes the travel-related data. In some embodiments, calculation program 122 analyzes the user communicated travel-related data to identify the accuracy of the data. In various embodiments, calculation program 122 identifies that the time and date of the travel-related data is accurate. In one embodiment and example, calculation program 122 identifies two time periods of travel for, at least, one user. Additionally, calculation program 122 determines that the two time periods communicated by the user overlap. For example, a user communicated, at least, one travel-related time period as January 1^{st} through January 5^{th} and, at least, a second travel-related time period as January 4^{th} through January 6^{th}. Calculation program 122 determines that the travel-related time periods cannot overlap and calculation program 122 retrieves additional travel-related data to corroborate the accuracy of the user communicated travel-related data. In various embodiments, calculation program 122 accesses database 134 and retrieves commercially accessible information. In various embodiments, calculation program 122 accesses a flight itinerary to determine the time and date that a flight departed and landed that is associated, at least, with the one user. Calculation program 122 identifies that the departure for the, at least, one user left a day earlier, but encountered a layover that persisted for two additional days. Calculation program 122 determines that the two travel-related time periods should reflect a single travel-related time period. In response to determining that the two travel-related time periods are a single travel-related time period, calculation program 122 updates the travel-related data to a single travel-related time period from January 1^{st} through January 6^{th}. In addition to updating the travel-related time period, calculation program 122 determines the state in which the layover occurred in and stores this data for tax calculation purposes.

In response to calculation program 122 calculating the total value of travel-related expenditures, calculation program 122 executes a comparison model to determine whether the current value of travel-related expenditures is (i) lower than, (ii) meets, or (iii) exceeds the established threshold value for the month of January. In an alternative embodiment, calculation program 122 includes, or has access to, a cognitive AI model to actively analyze the travel-related data and travel-related expenditures and executes a prediction-based model to determine whether the monthly threshold value will be exceeded based, at least in part, on the (i) current, (ii) subsequent, and (iii) predicted, travel-related data and travel-related expenditures communicated from client device 140.

In various embodiments, calculation program 122 includes, or has access to, a convolutional neural network, wherein calculation program 122 actively analyzes the travel-related data that is communicated to database 134. Additionally, calculation program 122 identifies various values of expenditures associated with the one or more travel-related data. Calculation program 122 evaluates the predicted expenditures of travel associated with one or more non-local users and identifies (i) one or more non-local users with a threshold value that is lower than an established percentile of non-local users, and (ii) one or more local users that can supplement the one or more non-local users that exceed the aforementioned threshold value of the established percentile of non-local users. In various embodiments of the present invention, non-local users include users that travel outside of the local jurisdiction (e.g., travel from one State to another State, or travel outside of a country, etc.) In response to the identification of the various values of expenditures, calculation program 122 determines when the monthly threshold value will be reached based, at least in part, on a prediction model associated with the various (i) travel-related data and expenditures, (ii) one or more non-local users, and (iii) one or more local users. In various embodiments, calculation program 122 determines that a non-local user will be unable to travel as a representative of the business entity based, at least, on when the monthly threshold value will be reached. In one embodiment and example, calculation program 122 determines that the monthly threshold value will be met on January 15^{th}, additionally, calculation program 122 determines that the thirtieth percentile of non-local users will be able to travel as a representative of the business entity, wherein the seventieth percentile will be unable to travel and one or more local users will be utilized as a representative of the business entity.

In response to determining when the monthly threshold value will be reached, calculation program 122 generates a modified schedule template and populates, at least, the modified schedule template with when the predicted monthly threshold value will be reached. Additionally, calculation program 122 populates the modified schedule template with data that represents, at least, (i) one or more non-local users that will be able to travel, and (ii) one or more local users that will be utilized instead of a percentile of non-local users.

In various embodiments, calculation program 122 generates an alert system based, at least in part, on the determination of when the threshold value will be met for a given month and communicates the alert to one or more users of client device 140. In some embodiment, calculation program 122 generates an alert and communicates the alert to client application 142 with program instructions instructing client application 142 to populate the alert on client interface 144 to communicate the alert to one or more users.

In various embodiments of the present invention, calculation program 122 generates an alert system that includes, but is not limited to, text, sound, image, etc. Additionally, the alert displays text that can include, but is not limited to, information regarding when the monthly threshold value will be reached, information communicated to one or more non-local users that will be able to travel, information communicated to one or more non-local users that will be unable to travel, and information communicated to one or more local users that will be supplemented for the one or more non-local users that will be unable to travel.

In an alternative embodiment, calculation program 122 receives travel related data and analyzes the travel-related data. In various embodiments, travel related data includes, but is not limited to, jurisdictional tax (e.g., state tax, local tax, international tax, etc.). The present invention recognizes that when a user travels from one jurisdiction to, at least, a second jurisdiction to conduct business on behalf of a business entity, that user encumbers a jurisdictional tax associated with the conducted business by the user. In various embodiments, calculation program 122 generates a template and populates the template with the travel-related data that includes, but is not limited to, the jurisdictional tax. In various embodiments, calculation program 122 identifies a threshold value associated with the travel-related data. In some embodiments, the threshold value includes, but is not limited to, a limit on the jurisdictional tax associated with one or more users of a business entity. In various embodiments, calculation program 122 determines when the monthly threshold value will be reached based, at least in part, on a prediction model associated with the various (i) one or more jurisdictional tax, (ii) one or more non-local users, and (iii) one or more local users. In various embodiments, calculation program 122 determines that a non-local user will be unable to travel as a representative of the business entity based, at least, on when the monthly threshold value will be reached that includes, but is not limited to, the jurisdictional tax.

In various embodiments, calculation program 122 generates a modified schedule template and populates the modified schedule template with when the predicted monthly threshold value will be reached. Additionally, calculation program 122 populates the modified schedule template with data that represents, at least, (i) one or more non-local users that will be able to travel, and (ii) one or more local users that will be utilized instead of a percentile of non-local users. In various embodiments, calculation program 122 stores the modified template on database 134 for subsequent use and access by a user of client device 140 utilizing, at least, client application 142 to retrieve the modified template. In some embodiments, calculation program 122 based, at least, on the analyzation operation, identifies a monthly threshold value associated with the jurisdictional tax. In various embodiments, calculation program 122 further determines when the monthly threshold value will be met for that given month based, at least, on the identification of the one or more travel-related data associated, at least, with the one or more jurisdictions where one or more non-local users have traveled or intend to travel.

In various embodiments, calculation program 122 generates one or more alerts and communicates the one or more alerts to client device 140 (e.g., one or more users of client device 140). In various embodiments, calculation program 122 generates an alert that is associated, at least, with the determination that the monthly threshold value associated with the jurisdictional tax will be met and communicates the alert to one or more users of client device 140. In some embodiments, calculation program 122 generates an alert that is associated, at least, with the determination that the monthly threshold value associated with the jurisdictional tax will be exceeded and communicates the alert to one or more users of client device 140.

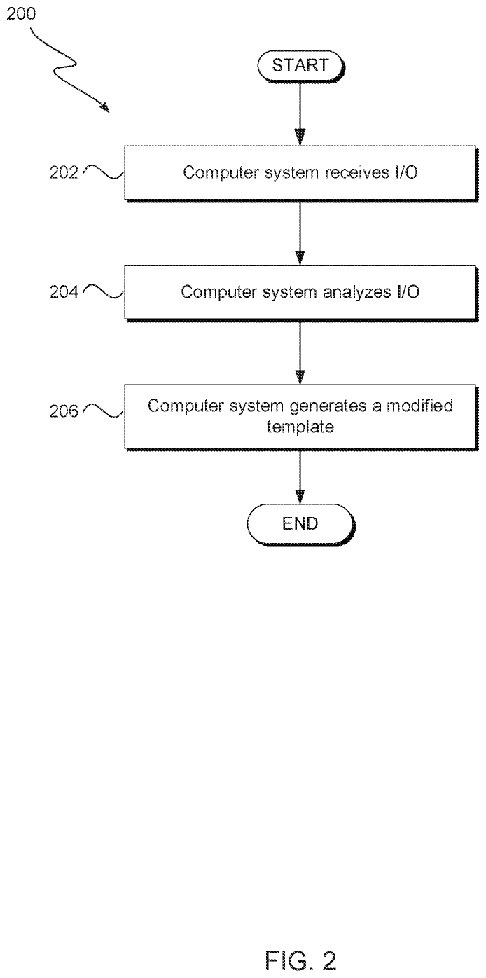

FIG. 2 is a flowchart, 200, depicting operations of calculation program 122 in computing environment 100, in accordance with an illustrative embodiment of the present invention. More specifically, FIG. 2, depicts combined overall operation 200 of calculation program 122 executing on computer system 120. In some embodiments, operations 200 represents logical operations of calculation program 122 executing on computer system 120. It should be appreciated that FIG. 2 provides an illustration of one implementation and does not imply any limitations with regard to the environments in which different embodiments may be implemented. Many modifications to the depicted environment may be made. In one embodiment of flowchart 200, the series of operations can be performed in any order. In another embodiment, the series of operations, of flowchart 200, can be performed simultaneously. Additionally, the series of operations, in flowchart 200, can be terminated at any operation. In addition to the features previously mentioned, any operations, of flowchart 200, can be resumed at any time.

In operation 202, calculation program 122 executing on computer system 120 receives I/O from client device 140 and/or SAN 130, as discussed above. In various embodiments, calculation program 122 receives I/O which includes, but is not limited to, (i) travel-related data and (ii) travel-related expenditures. In some embodiments, calculation program 122 generates a template which represents, but is not limited to, a graphical interactive table. In response to generating the template, calculation program 122 populates the template with (i) one or more travel-related data and (ii) travel-related expenditures, which are associated with, at least, one or more users of client device 140.

In operation 204, calculation program 122 analyzes the I/O populated into the template. In various embodiments, calculation program 122 analyzes, at least, (i) the one or more travel-related data and (ii) the one or more travel-related expenditures, associated, at least, with one or more users. In various embodiments, calculation program 122 represents a cognitive AI model, as discussed above, and analyzes the data to identify various trends and/or patterns associated, at least, with the threshold value. In some embodiments, calculation program 122 identifies one or more monthly threshold values (e.g., twelve monthly threshold values that are established by a primary user of a business entity) and analyzes the travel-related data and travel-related expenditures. In various embodiments, calculation program 122 determines when a given monthly threshold value will be reached based, at least, on a cognitive AI model.

In various embodiments of the present invention, calculation program 122 identifies one or more travel-related expenditures associated, at least, with (i) one or more users of client device 140 and (ii) a given period of time (e.g., the month of January). Calculation program 122 calculates the total value of the travel-related expenditures associated with (i) one or more users of client device 140 and (ii) a given period of time (e.g., the month of January). In various embodiments, calculation program 122 executes a comparison model to determine whether the total value of the travel-related expenditures will exceed the monthly threshold value for the given period of time. In various embodiments, calculation program 122 executes a cognitive AI model to analyze the data and determine whether the monthly threshold value will be exceeded based, at least in part, on the travel-related data submitted by the one or more users of client device 140.

In response to the identification of the various values of expenditures, calculation program 122 determines when the monthly threshold value will be reached based, at least in part, on a prediction model associated with the various (i) travel-related data and expenditures, (ii) one or more non-local users, and (iii) one or more local users. In various embodiments, calculation program 122 determines that a non-local user will be unable to travel as a representative of the business entity based, at least, on when the monthly threshold value will be reached.

In operation 206, calculation program 122 generates a modified schedule template and populates the modified schedule template with when the predicted monthly threshold value will be reached. Additionally, calculation program 122 populates the modified schedule template with data that represents, at least, (i) one or more non-local users that will be able to travel, and (ii) one or more local users that will be utilized instead of a percentile of non-local users. In various embodiments, calculation program 122 stores the modified template on database 134 for subsequent use and access by a user of client device 140 utilizing, at least, client application 142 to retrieve the modified template. In another embodiment, calculation program 122 communicates the modified template to client application 142 with program instructions instructing client application 142 to populate client interface 144 with the modified template.

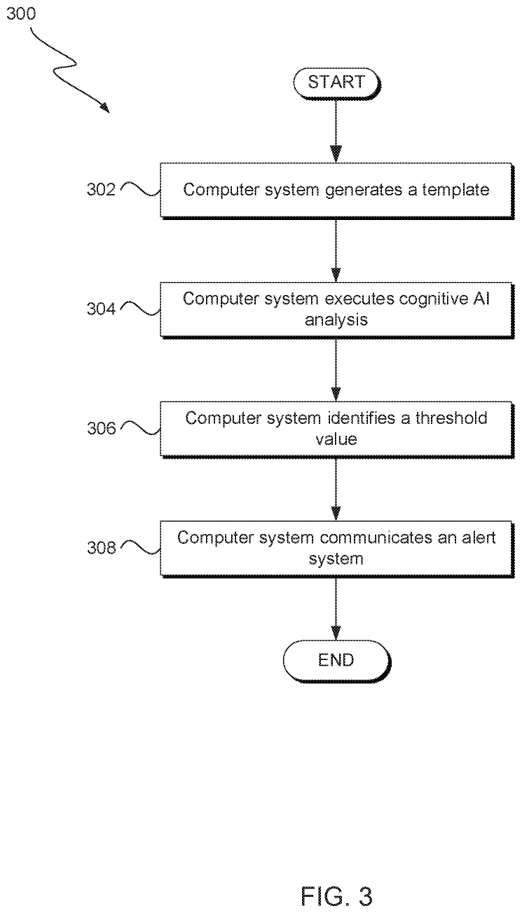

FIG. 3 depicts a flowchart depicting operations for an alert system for computing environment 100, in accordance with an illustrative embodiment of the present invention. More specifically, FIG. 3, depicts combined overall operations, 300, of calculation program 122 executing on computer system 120. It should be appreciated that FIG. 3 provides an illustration of one implementation and does not imply any limitations with regard to the environments in which different embodiments may be implemented. Many modifications to the depicted environment may be made. In one embodiment of flowchart 300, the series of operations can be performed in any order. In another embodiment, the series of operations, of flowchart 300, can be performed simultaneously. Additionally, the series of operations, in flowchart 300, can be terminated at any operation. In addition to the features previously mentioned, any operation, of flowchart 300, can be resumed at any time.

In operation 302, calculation program 122 generates a template that is associated, at least, with (i) one or more users, (ii) one or more travel-related data, and (iii) one or more travel-related expenditures. In various embodiments, the template generated by calculation program 122 is a GUI that a user of client device 140 interacts with. In some embodiments calculation program 122 communicates the template to client device 140 with program instructions to populate the template on client interface 144.

In operation 304, calculation program 122 represents a cognitive AI model and analyzes various I/O. In various embodiments, calculation program 122 learns from the I/O (e.g., travel-related data, travel-related expenditures, etc.) based, at least in part, on the analyzation operation, and executes a prediction model. The calculation program 122 analyzes one or more travel-related data communicated by SAN 130 and/or client device 140. In various embodiments, calculation program 122 identifies one or more jurisdictions where one or more non-local users have traveled or intend to travel. Additionally, in various embodiments, calculation program 122 identifies one or more expenditures associated, at least, with the one or more jurisdictions where one or more non-local users have traveled or intend to travel. In some embodiments, calculation program 122 executes a prediction model, wherein calculation program 122 predicts whether one or more non-local users will travel in a subsequent time period within a given month.

In operation 306, calculation program 122 based, at least, on the analyzation operation, identifies a monthly threshold value from, at least, the travel-related data. In various embodiments, calculation program 122 further determines when the monthly threshold value will be met for that given month based, at least, on the identification of the one or more expenditures associated, at least, with the one or more jurisdictions where one or more non-local users have traveled or intend to travel.

In various embodiments of the present invention, calculation program 122 determines whether the monthly threshold value will be met, exceeded, or undervalue. In some embodiments, calculation program 122 determines that the monthly threshold value will be met based, at least, on the analyzation on the travel-related data and travel-related expenditures. In some embodiments, calculation program 122 determines that the monthly threshold value will be exceed based, at least, on the analyzation of the travel-related data and travel-related expenditures. In response to calculation program 122 determining that the monthly threshold value will be exceeded, calculation program 122 identifies one or more non-local users that will be unable to travel based, at least, on the time period after the threshold value is exceeded. Additionally, calculation program 122 identifies one or more local users that will be utilized to supplement the non-local users who will be unable to travel. In yet some embodiments, calculation program 122 determines that the monthly threshold value will not be met, and further determines that the total travel-related expenditures for a given month will be lower than the monthly threshold value.

In operation 308, calculation program 122 generates one or more alerts and communicates the one or more alerts to client device 140 (e.g., one or more users of client device 140). In various embodiments, calculation program 122 generates an alert that is associated, at least, with the determination that the monthly threshold value will be met and communicates the alert to one or more users of client device 140. In some embodiments, calculation program 122 generates an alert that is associated, at least, with the determination that the monthly threshold value will be exceeded. In response to generating an alert that is associated with the determination that the monthly threshold value will be exceeded, calculation program 122 communicates an alert to one or more non-local users informing the non-local users that they will be unable to travel. Additionally, calculation program 122 communicates an alert to one or more local users informing the local users that they will be utilized in place of the non-local users.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

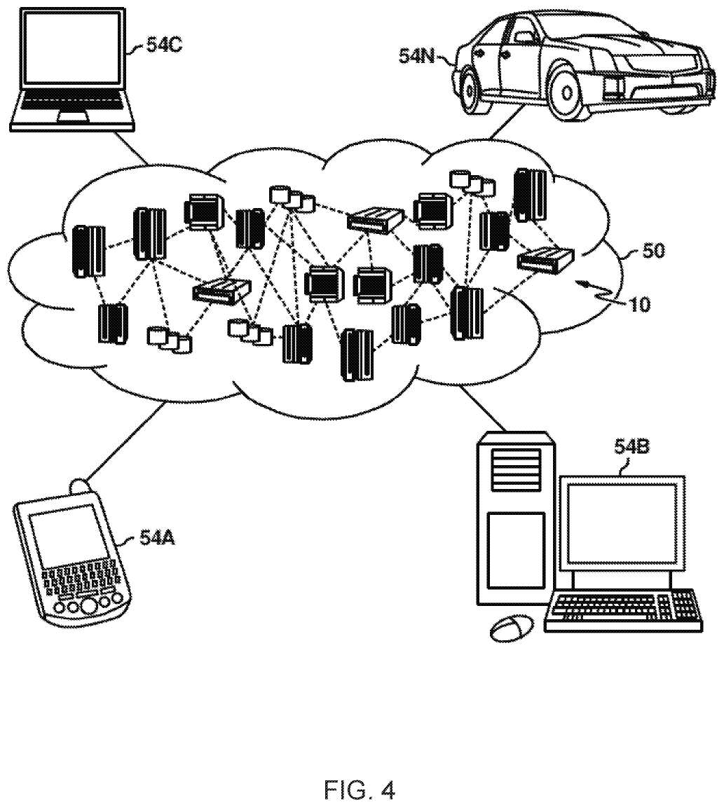

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

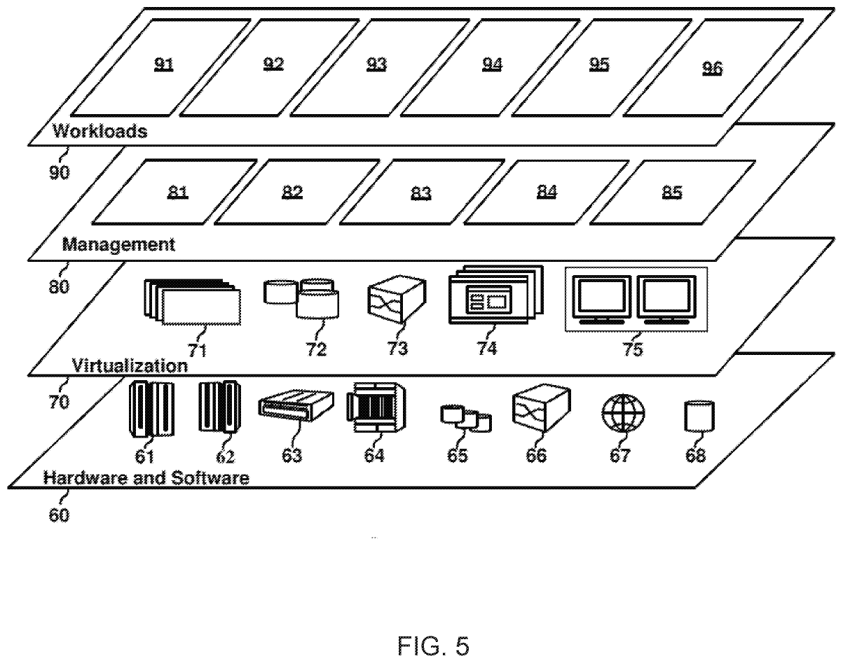

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing soothing output 96.

FIG. 6 depicts a block diagram, 600, of components of computer system 120, SAN 130, and client device 140, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computer system 120, SAN 130, and client device 140 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

Calculation program 122, computer interface 124, server application 132, database 134, client application 142, and client interface 144 are stored in persistent storage 608 for execution and/or access by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices, including resources of network 110. In these examples, communications unit 610 includes one or more network interface cards. Communications unit 610 may provide communications through the use of either or both physical and wireless communications links. Calculation program 122, computer interface 124, server application 132, database 134, client application 142, and client interface 144 may be downloaded to persistent storage 608 through communications unit 610.

I/O interface(s) 612 allows for input and output of data with other devices that may be connected to computer system 120, SAN 130, and client device 140. For example, I/O interface 612 may provide a connection to external devices 618 such as a keyboard, keypad, a touch screen, and/or some other suitable input device. External devices 618 can also include portable computer-readable storage media such as, for example, thumb drives, portable optical or magnetic disks, and memory cards. Software and data used to practice embodiments of the present invention, e.g., Calculation program 122, computer interface 124, server application 132, database 134, client application 142, and client interface 144, can be stored on such portable computer-readable storage media and can be loaded onto persistent storage 608 via I/O interface(s) 612. I/O interface(s) 612 also connect to a display 620.

Display 620 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A computer-implemented method, the method comprising:
determining, by one or more processors, one or more travel-related data for a given time period;
determining, by one or more processors, one or more expenditures based, at least, on the one or more travel-related data; and
generating, by one or more processors, a graphical template based, at least, on an expenditure target.

2. The computer-implemented method of claim 1, the method further comprising:
receiving, by the one or more processors, a user request;
analyzing, by the one or more processors, the user request;
identifying, by the one or more processors, (i) the one or more travel-related data and (ii) one or more travel-related expenditures;
receiving, by the one or more processors, (i) the one or more travel-related data and (ii) the one or more travel-related expenditures; and
identifying, by the one or more processors, one or more data points associated with (i) the one or more travel-related data and (ii) the one or more travel-related expenditures.

3. The computer-implemented method of claim 2, the method further comprising:
in response to identifying (i) the one or more travel-related data and (ii) the one or more travel-related expenditures, generating, by the one or more processors, the one or more graphical templates; and
populating, by the one or more processors, the one or more graphical templates with (i) the one or more travel-related data and (ii) the one or more travel-related expenditures.

4. The computer-implemented method of claim 2, the method further comprising:
identifying, by the one or more processors, a maximum threshold value associated with a limit on the travel-related expenditures;
analyzing, by the one or more processors, the maximum threshold value associated with a limit on the travel-related expenditures; and
in response to analyzing the maximum threshold value, determining, by the one or more processors, one or more monthly threshold values, wherein a culmination of the one or more monthly threshold values equals the maximum threshold value.

5. The computer-implemented method of claim 4, the method further comprising:
monitoring, by the one or more processors, one or more additional travel-related expenditures during a given time period;
identifying, by the one or more processors, the one or more additional travel-related expenditures associated with the one or more monthly threshold values;
calculating, by the one or more processors, the monthly threshold value based on the one or more additional travel-related expenditures; and
analyzing, by the one or more processors, the one or more additional travel-related expenditures utilizing a cognitive model, wherein the cognitive model analyzes the one or more additional travel-related expenditures and generates a prediction of a monthly threshold total for a given time period.

6. The computer-implemented method of claim 5, the method further comprising:
receiving, by the one or more processors, the one or more additional travel-related expenditures associated with the one or more monthly threshold values;
in response to calculating the monthly threshold value based on the one or more additional travel-related expenditures, generating, by the one or more processors, a modified template; and
populating, by the one or more processors, the modified template with (i) the one or more additional travel-related expenditures and (ii) the calculated monthly threshold value.

7. The computer-implemented method of claim 5, the method further comprising:
analyzing, by the one or more processors, the modified template with (i) the one or more additional travel-related expenditures and (ii) the calculated monthly threshold value;
identifying, by the one or more processors, when the monthly threshold value will be met for a given time period;
determining, by the one or more processors, whether the monthly threshold value will be met before the conclusion for a given time period; and
in response to determining that the monthly threshold value will be met before the conclusion for a given time period, generating, by the one or more processors, an alert system associated with the monthly threshold value being met.

8. A computer program, the computer program product comprising:
one or more computer-readable storage media and program instructions stored on the one or more computer-readable storage media, the program instructions comprising:
program instructions to determine one or more travel-related data for a given time period;
program instructions to determine one or more expenditures based, at least, on the one or more travel-related data; and
program instructions to generate a graphical template based, at least, on an expenditure target.

9. The computer program product of claim 8, the program instructions further comprising:
program instructions to receive a user request;
program instructions to analyze the user request;
program instructions to identify identifying, by the one or more processors, (i) the one or more travel-related data and (ii) the one or more travel-related expenditures;
program instructions to receive (i) the one or more travel-related data and (ii) the one or more travel-related expenditures; and
program instructions to identify one or more data points associated with (i) the one or more travel-related data and (ii) the one or more travel-related expenditures.

10. The computer program product of claim 9, the program instructions further comprising:
in response to identifying (i) the one or more travel-related data and (ii) the one or more travel-related expenditures, program instructions to generate one or more templates; and
program instructions to populate the one or more graphical templates with one or more data points associated with (i) the one or more travel-related data and (ii) the one or more travel-related expenditures.

11. The computer program product of claim 9, the program instructions further comprising:
program instructions to identify a maximum threshold value associated with a limit on travel-related expenditures;
program instructions to analyze the maximum threshold value associated with a limit on travel-related expenditures; and
in response to analyzing the maximum threshold value, program instructions to determine one or more monthly threshold values, wherein the culmination of the one or more monthly threshold values equals the maximum threshold value.

12. The computer program product of claim 11, the program instructions further comprising:
program instructions to monitor the one or more additional travel-related expenditures during a given time period;
program instructions to identify the one or more additional travel-related expenditures associated with the one or more monthly threshold values;
program instructions to calculate the monthly threshold value based on the one or more additional travel-related expenditures; and
program instructions to analyze the one or more additional travel-related expenditures utilizing a cognitive model, wherein the cognitive model analyzes the one or more additional travel-related expenditures and generates a prediction of a monthly threshold total for a given time period.

13. The computer program product of claim 12, the program instructions further comprising:
program instructions to receive the one or more additional travel-related expenditures associated with the one or more monthly threshold values;
in response to calculating the monthly threshold value based on the one or more additional travel-related expenditures, program instructions to generate a modified template; and
program instructions to populate the modified template with (i) the one or more additional travel-related expenditures and (ii) the calculated monthly threshold value.

14. The computer program product of claim 12, the program instructions further comprising:
program instructions to analyze the modified template with (i) the one or more additional travel-related expenditures and (ii) the calculated monthly threshold value;
program instructions to identify when the monthly threshold value will be met for a given time period;
program instructions to determine whether the monthly threshold value will be met before the conclusion for a given time period; and
in response to determining that the monthly threshold value will be met before the conclusion for a given time period, generating, by the one or more processors, an alert system associated with the monthly threshold value being met.

15. A computer system, the computer system comprising:
one or more computer processors;
one or more computer readable storage medium; and
program instructions stored on the computer readable storage medium for execution by at least one of the one or more processors, the program instructions comprising:
program instructions to determine one or more travel-related data for a given time period;
program instructions to determine one or more expenditures based, at least, on the one or more travel-related data; and
program instructions to generate a graphical template based, at least, on an expenditure target.

16. The computer system of claim 15, the program instructions further comprising:
program instructions to receive a user request;
program instructions to analyze the user request;
program instructions to identify identifying, by the one or more processors, (i) the one or more travel-related data and (ii) the one or more travel-related expenditures;
program instructions to receive (i) the one or more travel-related data and (ii) the one or more travel-related expenditures; and
program instructions to identify one or more data points associated with (i) the one or more travel-related data and (ii) the one or more travel-related expenditures.

17. The computer system of claim 16, the program instructions further comprising:
program instructions to identify a maximum threshold value associated with a limit on the travel-related expenditures;
program instructions to analyze the maximum threshold value associated with a limit on the travel-related expenditures; and
in response to analyzing the maximum threshold value, program instructions to determine one or more monthly threshold values, wherein the culmination of the one or more monthly threshold values equals the maximum threshold value.

18. The computer system of claim 17, the program instructions further comprising:
program instructions to monitor the one or more additional travel-related expenditures during a given time period;
program instructions to identify the one or more additional travel-related expenditures associated with the one or more monthly threshold values;
program instructions to calculate the monthly threshold value based on the one or more additional travel-related expenditures; and
program instructions to analyze the one or more additional travel-related expenditures utilizing a cognitive model, wherein the cognitive model analyzes the one or more additional travel-related expenditures and generates a prediction of a monthly threshold total for a given time period.

19. The computer system of claim 18, the program instructions further comprising:
program instructions to receive the one or more additional travel-related expenditures associated with the one or more monthly threshold values;
in response to calculating the monthly threshold value based on the one or more additional travel-related expenditures, program instructions to generate a modified template; and
program instructions to populate the modified template with (i) the one or more additional travel-related expenditures and (ii) the calculated monthly threshold value.

20. The computer system of claim 18, the program instructions further comprising:
program instructions to analyze the modified template with (i) the one or more additional travel-related expenditures and (ii) the calculated monthly threshold value;
program instructions to identify when the monthly threshold value will be met for a given time period;
program instructions to determine whether the monthly threshold value will be met before the conclusion for a given time period; and
in response to determining that the monthly threshold value will be met before the conclusion for a given time period, generating, by the one or more processors, an alert system associated with the monthly threshold value being met.
